(19) United States
(12) Patent Application Publication
(10) Pub. No.: US 2008/0250485 A1
(43) Pub. Date: Oct. 9, 2008

(54) Guest Dongle and Method of Connecting Guest Apparatuses to Wireless Home Networks

(75) Inventors: Oliver Schreyer, Herzogenrath (DE); Bozena Erdmann, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,427

(22) PCT Filed: Jan. 26, 2005
(86) PCT No.: PCT/IB2005/050307

§ 371 Date: Jul. 25, 2006

(30) Foreign Application Priority Data
Jan. 29, 2004 (EP) 04100322.9

(51) Int. Cl. H04L 29/06

(52) U.S. Cl. 726/9; 726/3

(57) ABSTRACT

The invention relates to a dongle (3) for access of guest apparatuses (2) to a wireless home network (1). The dongle (3) comprises a memory and processing unit (33) which is connected to the guest apparatus (2) by means of an antenna (32) as well as a configuration-free interface (31). The invention also relates to a method of connecting guest apparatuses (2) to wireless home networks (1), wherein the access of the guest apparatus (2) is realized via a dongle (3) which is connected to an interface (31) of the guest apparatus (2).

The invention relates to a guest dongle for wireless home networks. The invention also relates to a method of connecting guest apparatuses to wireless home networks.

In future, consumer electronics apparatuses will be interconnected via digital home networks. The wireless transmission technology has made more and more progress and will eventually lead to a large number of wireless home networks. Initially, the user of a home network wants to have a closed network which provides the required services (including Internet access), protected from any external access. This is a technical challenge, particularly for wireless networks. It is to be ensured that wireless transmission is protected from unauthorized access or interception. Users of such home networks will, however, need functionalities which can be opened to guest access in a controlled manner. The guest will often bring his own apparatus and connect it to the home network. The following problems are then to be solved. The connection between the guest apparatus and the home network must be made in a simple and secure way. The access time as well as the rights of guest access should be controllable. Furthermore, the network security must have the same level in the case of guest access as in the case of a closed network.

To this end, it is an object of the invention to provide a connection between the guest apparatus and the home network in a simple and secure way. Access times and rights of guest access should be controllable and the network security should be secured in the same way as in the closed network.

This object is achieved by a guest dongle comprising a memory and processing unit which is connected to the guest apparatus by means of an antenna as well as a configuration-free interface. This object is further achieved in that the access to the guest apparatus is realized via a guest dongle which is connected to the guest apparatus. The dongle is the property of the home network, i.e. it belongs to the home user who configures this network that has two main interfaces, namely the connection interface for the guest apparatus, which is a standardized, network-capable and configuration-free interface such as USB or Ethernet, and a home interface, which is a radio interface for connection to the home network. Dongle and home network are designed in such a way that the only action by the user for realizing a secure and controlled guest access to the home network consists in connecting the dongle. After establishing the connection and network configuration, the dongle reports to the home network independently.

To establish the connection with the wireless home network, the dongle needs configuration parameters, particularly a network identifier and cryptographic keys. These are loaded once, for example, by means of the short-range key transmitters (SKT) via a further interface (for example, infrared or smart card reader). A further possibility is to insert the dongle into a special loading apparatus so as to load the configuration data via the connection interface of the dongle.

The dongle is preferably equipped with a firewall so as to stop viruses, trojans, etc. The firewall may also be used to monitor the data stream in both directions.

In a further embodiment of the invention, the dongle may be equipped with biometric devices such as a fingerprint scanner or the like for the purpose of user authentication. Unauthorized use of the dongle is thereby prevented.

The dongle is preferably connected as an IP router to the network. This prevents direct access to network resources by the guest apparatus.

In a further embodiment of the invention, the dongle acts as a bridge (MAC bridge) and transmits the data stream between the guest apparatus and the home network.

In another embodiment of the invention, the dongle comprises a card reader as a configuration interface. This provides the possibility of configuring the dongle via mobile storage media such as smart cards, etc.

These and other aspects of the invention are apparent from and will be elucidated with reference to the embodiments described hereinafter.

In the drawings:

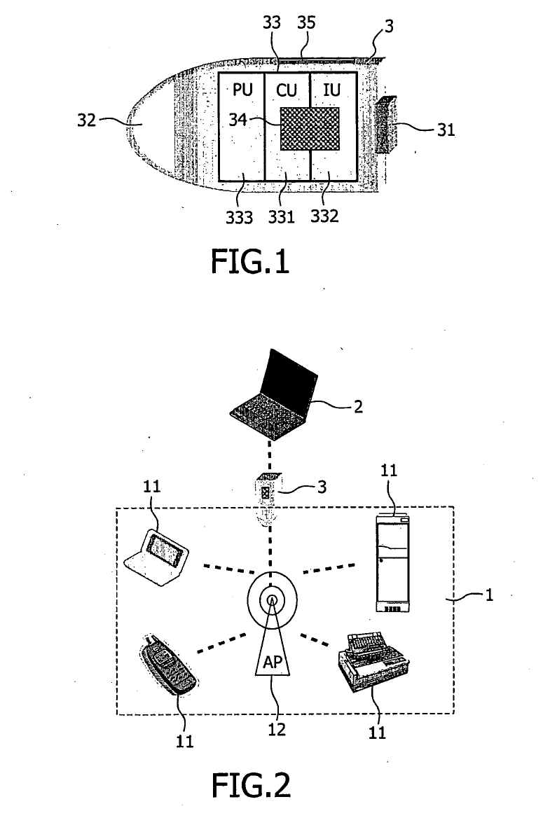

FIG. 1 shows diagrammatically a dongle for connection of a guest apparatus to a wireless home network, and

FIG. 2 shows diagrammatically the connection of a guest apparatus to a wireless home network by means of a dongle as shown in FIG. 1.

The guest dongle 3 shown in FIG. 1 has a USB interface 31 for connection to the guest apparatus 2. The data technical connection between the dongle 3 and the guest apparatus 2 as well as the current supply for the dongle 3 are realized via the USB interface 31. An antenna 32 which is based on the WLAN standard IEEE 802.11 is provided on the side opposite the USB interface 31. Arranged between the USB interface 31 and the antenna 32 is a memory and processing unit (MPU) 33 which processes the data received via the interface 31 and the antenna 32 and subsequently sends them to the home network 1 or the guest apparatus 2 via the antenna 32 or the interface 31. The MPU 33 comprises a configuration unit (CU) 331 in which configuration-relevant data are stored, an identification unit (IU) 332 for recording and checking user data, as well as a protection unit (PU) 333 comprising mechanisms such as firewall, virus scanner, etc. for protecting the data streams.

The IU 332 is connected to a fingerprint scanner 34 which is arranged on the upper side of the dongle 3. The biometrical data of the fingerprints of the authorized user of the dongle are stored in the IU 332 and compared with the user's fingerprint whenever the dongle is used.

A card reader 35 is arranged on the side of the dongle 3. It is used as a configuration interface of the dongle 3, via which information from mobile storage media such as smart cards, etc. can be read.

The home network 1 shown in FIG. 2 consists of different network apparatuses 11 which are interconnected via an access point (AP) 12 in a wireless manner. A guest apparatus 2 gains access to the home network 1 via the guest dongle 3. To this end, the guest dongle 3 is initially configured for access to the wireless home network 1. This may be done in different ways. Preferably, a so-called short-range key transmitter (SKT) is used (once, for example, upon first installation after purchase). Dependent on its form, the guest dongle requires a further interface for this purpose. To this end, the dongle 3 in accordance with the embodiment has a smart card reader 34. Alternatively, the use of an infrared or Bluetooth interface is also feasible. After establishing the connection configuration, the guest dongle uses standardized automatic configuration mechanisms such as DHCP or auto IP for completing the network configuration. When the guest dongle is formed as an IP router, it may comprise a DHCP server which allocates an IP address to the guest apparatus. When it is formed as a MAC bridge, this may be done by the DNCP server of the home network.

Alternatively, the guest dongle may also be connected to a special load apparatus which transmits the required configuration data to the dongle 3. The guest dongle 3 permanently stores the transmitted configuration data in the MPU 33 (for example, upon first configuration after purchase of the dongle).

In this embodiment, the guest apparatus 2 is connected to the guest dongle 3 via a USB interface 31. This interface has the advantage that it does not require any further configuration and, moreover, provides the possibility of integrated current supply for the guest dongle 3. The communication between the guest dongle 3 and the access point 12 of the home network 1 is realized via the antenna 32 which, in this embodiment, is based on the IEEE 802.11 standard.

The CU 331 of the guest dongle 3 has software functions which provide an IP address for the guest apparatus 2. The guest dongle 3 then acts as a router, i.e. the communication between the guest dongle 3 and the access point 12 of the home network 1 is realized via another IP address which is not visible to the guest apparatus. Due to the guest dongle 3, the configuration of the wireless interface of the home network 1 (particularly network identification and keys) is not visible to the guest apparatus 2 and, consequently, cannot be used for unauthorized access at a later point of time.

Alternatively, the guest dongle 3 may also be formed as a “bridge”. In this case, it provides the guest apparatus 2 with an IP address made available by the home network 1, as well as with required configuration data, and subsequently serves only for passing on information between the guest apparatus 2 and the home network 1. However, in this case, the security functions of the PU 333 must be performed comprehensively because the guest apparatus 2 quasi-obtains a direct connection to the access point 12 via the allocated IP address.

After establishing the connection, including the required configurations, the guest dongle 3 signalizes the presence of the guest apparatus 2 in the home network 1. This may be realized via a suitable protocol. It is further possible that the guest dongle 3 informs the DHCP server of the home network 1 about the request to be expected from the guest apparatus 2 (which is realized via the guest dongle 3 as a “bridge”).

In the simplest case, the guest dongle 3 allows the guest apparatus 2 unlimited access to the resources of the home network 1. Sensitive data and services may additionally be protected, for example, by means of a password. Alternatively, a manual pre-registration between guest dongle 3 and network apparatus 11 may be performed. This may be realized, for example, via the connection of the guest dongle 3 to the corresponding network apparatuses in which the relevant information is exchanged. During guest access, only the pre-registered network apparatuses 11 can be reached in this case via the guest dongle 3.

Access to the resources of the home network is preferably controlled via a user or apparatus access manager within the home network 1. For example, each request comprises an identification code of the user or of the apparatus 2 so that the control functions of the manager can check whether the requesting apparatus or the requesting user is authorized to make the request. This mechanism is supported by the guest dongle 3 in the following way.

Subsequent to the configuration, the guest dongle 3 reports the new guest or the new guest apparatus 2 to the home network in an unambiguously identifiable manner, for example, via the IP address which is used by the guest dongle 3, or via the (unambiguous) MAC address of the home interface. Thus, all requests made by the guest apparatus 2 can be identified and treated accordingly.

As a further function, the guest dongle 3 can provide the guest apparatus 2 with identification codes, for example, in the form of a PIN, which codes are to be used at every subsequent request via the guest dongle 3. These identification codes are known to the access manager of the home network or are transmitted by the guest dongle 3 during the configuration process.

In another embodiment, the guest dongle 3, prior to the configuration, has information regarding the access rights of the guest or receives this information during the configuration. When the guest apparatus 2 is being connected to the home network 1, the guest dongle 3 filters all unauthorized requests in advance.

A supplementary aspect of guest access is the protection of the guest apparatus 2. It comprises hiding applications and contents of the guest apparatus so that only a limited selection of data and services on the side of the network is visible or available. It is thereby prevented that, for example, a copy of the data stored on the guest apparatus 2 is stealthily made by a member of the home network 1.

### LIST OF REFERENCE NUMERALS

1 home network
2 guest apparatus
3 dongle
11 network apparatus
12 access point (WLAN)
31 USB interface
32 antenna
33 memory and processing unit (MPU)
331 configuration unit (CU)
332 identification unit (IU)
333 protection unit (PU)
34 fingerprint scanner
35 card reader

1. A dongle (3) for access of guest apparatuses (2) to a wireless home network (1), comprising a memory and processing unit (33) which is connected to the guest apparatus (2) by means of an antenna (32) as well as a configuration-free interface (31).

2. A dongle as claimed in claim 1, characterized in that the configuration-free interface (31) is a USB interface.

3. A dongle as claimed in claim 2, characterized in that the current supply for the dongle (3) is realized via the USB interface (31).

4. A dongle as claimed in claim 1, characterized in that the dongle (3) has an integrated protection unit (333) such as, for example, a firewall or a virus scanner.

5. A dongle as claimed in claim 1, characterized in that the dongle (3) has a biometric device (33) for user authentication.

6. A dongle as claimed in claim 5, characterized in that the biometric device (33) is a fingerprint scanner.

7. A dongle as claimed in claim 1, characterized in that the dongle (3) has an additional configuration interface (34).

8. A dongle as claimed in claim 7, characterized in that the configuration interface (34) is a card reader.

9. A method of connecting guest apparatuses to wireless home networks, wherein the access of the guest apparatus (2) is realized via a dongle (3) which is connected to an interface (31) of the guest apparatus (2).

10. A method as claimed in claim 9, characterized in that the dongle (3) reports to the home network (1) independently.

11. A method as claimed in claim 9, characterized in that configuration parameters, which are loaded via an interface (35) of the dongle (3), are stored in the dongle (3).

12. A method as claimed in claim 9, characterized in that the home interface configuration of the dongle (3) is not visible to the guest apparatus (2).

13. A method as claimed in claim 9, characterized in that the dongle (3) acts as a router between the guest apparatus (2) and the home network (1) and that, to this end, the guest apparatus (2) has an appropriate IP address.
